(19) United States
(12) Patent Application Publication
(10) Pub. No.: US 2013/0113777 A1
(43) Pub. Date: May 9, 2013

(54) METHOD OF TRANSFERRING DATA IN A DISPLAY DEVICE

(71) Applicants: Dong-Hoon Baek, Seoul (KR); Jae-Youl Lee, Hwaseong-si (KR); Dong-Myung Lee, Suwon-si (KR); Han-Su Pae, Seongnam-si (KR)

(72) Inventors: Dong-Hoon Baek, Seoul (KR); Jae-Youl Lee, Hwaseong-si (KR); Dong-Myung Lee, Suwon-si (KR); Han-Su Pae, Seongnam-si (KR)

(21) Appl. No.: 13/370,810

(22) Filed: Feb. 10, 2012

(30) Foreign Application Priority Data
Nov. 9, 2011 (KR) 10-2011-0116387

(51) Int. Cl. G09G 5/00

(52) U.S. Cl. 345/212

(57) ABSTRACT

A method of transferring data between a timing controller and a plurality of source drivers in a display device is disclosed. The method includes: (a) setting a first source driver of the plurality of source drivers to convert first signals having first voltage levels to second signals having second voltage levels; (b) receiving, by the first source driver, a first test pattern from the timing controller; (c) performing a test by the first source driver, based on the first test pattern, to determine whether an error has occurred in the first test pattern; and (d) when an error has occurred in the first test pattern, adjusting, by the first source driver, an output level of a receiver of the first source driver, so that the first source driver converts the first signals to third signals having third voltage levels different from the second voltage levels.

### CROSS-REFERENCE TO RELATED APPLICATION(S)

This application claims priority under 35 USC §119 to Korean Patent Application No. 10-2011-0116387, filed on Nov. 9, 2011, in the Korean Intellectual Property Office (KIPO), the contents of which are incorporated herein in their entirety by reference.

### BACKGROUND

1. Technical Field

Example embodiments generally relate to an intra-panel interface, and more particularly to a method of transmitting display data between a timing controller and a source driver.

2. Description of the Related Art

A display device employs an intra-panel interface for transferring data from a timing controller to source drivers. For example, reduced swing differential signaling (RSDS), mini low voltage differential signaling (mini-LVDS), point-to-point differential signaling (PPDS), and low current differential signaling have been developed as the intra-panel interface.

### SUMMARY

Some example embodiments provide a method of transferring data between a timing controller and a source driver, which is capable of reducing power consumption.

According to one embodiment, a method of transferring data between a timing controller and a plurality of source drivers in a display device is disclosed. The method includes: (a) setting a first source driver of the plurality of source drivers to convert first signals received from outside of the first source driver and having first voltage levels to second signals having second voltage levels; (b) receiving, by the first source driver, a first test pattern from the timing controller; (c) performing a test by the first source driver, based on the first test pattern, to determine whether an error has occurred in the first test pattern received at the first source driver; and (d) when an error has occurred in the first test pattern received at the first source driver, adjusting, by the first source driver, an output level of a receiver of the first source driver, so that the first source driver converts the first signals to third signals having third voltage levels different from the second voltage levels.

According to another embodiment, a method of transferring data between a timing controller and a plurality of source drivers in a display device is disclosed. The method includes: (a) receiving, by a first source driver of the plurality of source drivers, a first test signal; (b) converting, by the first source driver, the first test signal to a first TTL level signal; (c) performing, by the first source driver, error checking for the first TTL level signal; (d) if it is determined that an error has occurred, adjusting settings of the first source driver; and (e) repeating steps (a) through (d) until it is determined that no error has occurred.

According to another embodiment, a display device comprises a timing controller and a plurality of source drivers. A first source driver of the plurality of source drivers includes: a first receiver configured to receive a first test pattern from the timing controller; and a first error check unit configured to perform a test, based on the first test pattern, to determine whether an error has occurred in the first test pattern. The first source driver is configured to adjust an output level of the first receiver when it is determined that an error has occurred in the first test pattern, so that signals output from the first receiver have different voltage levels after the adjustment than prior to the adjustment.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a display device according to example embodiments.

FIG. 2A is a block diagram illustrating one of the source drivers in FIG. 1 according to example embodiments.

FIG. 2B illustrates a portion of the display device of FIG. 1, according to certain exemplary embodiments.

FIG. 3 is a state diagram illustrating an example of operating modes of a display device illustrated in FIG. 1, according to certain exemplary embodiments.

FIG. 4A is a flow chart illustrating a method of transferring data in a display device of FIG. 1, according to certain exemplary embodiments.

FIG. 4B is a flow chart illustrating the step S330 in FIG. 4A, according to certain exemplary embodiments.

FIG. 5 is a diagram illustrating signals transferred in a display device of FIG. 1, according to certain exemplary embodiments.

FIG. 6 is a diagram illustrating a data corresponding to one line of an image frame during a data transfer period, according to certain exemplary embodiments.

FIG. 7 is a table illustrating a relationship between the test pattern and the configuration data in FIG. 6, according to certain exemplary embodiments.

FIG. 8 illustrates an output of one of the amplifiers in the amplifying unit in FIG. 3 according to the bias information included in the configuration file in FIG. 6, according to certain exemplary embodiments.

FIG. 9 illustrates one of the amplifiers in the amplifying unit in FIG. 3, according to certain exemplary embodiments.

FIG. 10 is a flow chart illustrating a controlling a bias voltage of a source driver according to some embodiments.

FIG. 11 is a diagram illustrating an example of a horizontal blank field and a line start field included in a data of FIG. 6, according to certain exemplary embodiments.

FIG. 12 is a diagram illustrating another example of a horizontal blank field and a line start field included in a data of FIG. 6, according to certain exemplary embodiments.

FIG. 13 is a diagram illustrating signals transferred in a display device of FIG. 1 according to some embodiments

FIG. 14 is a diagram illustrating signals transferred in a display device of FIG. 1 according to other embodiments.

FIG. 15 is a diagram illustrating an example of a modulated clock signal transferred during a vertical blank period, according to certain exemplary embodiments.

FIG. 16 is a diagram illustrating another example of a modulated clock signal transferred during a vertical blank period, according to certain exemplary embodiments.

FIG. 17 is a diagram illustrating still another example of a modulated clock signal transferred during a vertical blank period, according to certain exemplary embodiments.

FIG. 18 is a block diagram for describing an example of an operation of a display device of FIG. 1 that transmits soft fail information, according to certain exemplary embodiments.

FIG. 19 is a block diagram illustrating a system including a display device of FIG. 1, according to certain exemplary embodiments.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “on,” or “connected” or “coupled” to another element, it can be directly on, directly connected to, or directly coupled to the other element or intervening elements may be present. In contrast, when an element is referred to as being “directly on,” “directly connected,” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

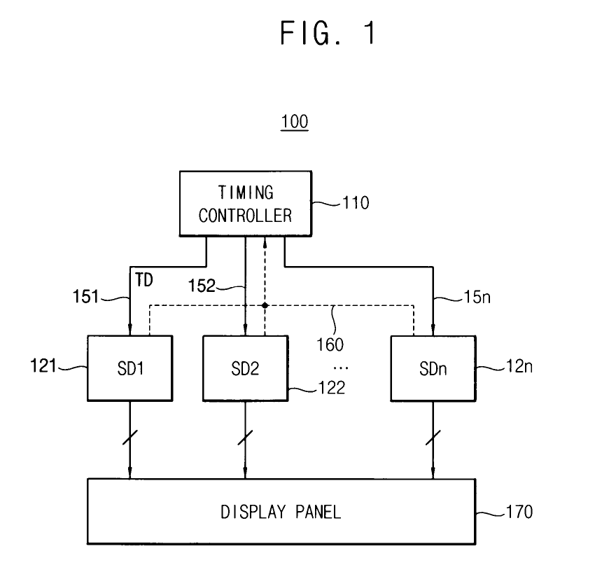

FIG. 1 is a block diagram illustrating a display device according to example embodiments.

Referring to FIG. 1, a display device 100 includes a timing controller 110, a plurality of source drivers 121˜12n and a display panel 170.

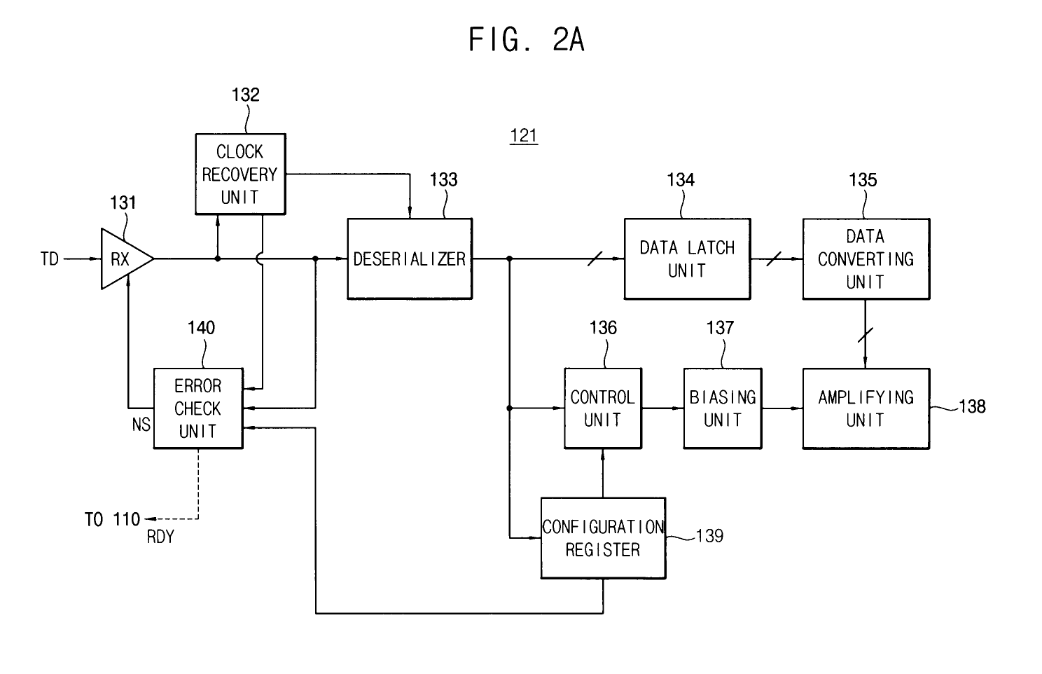

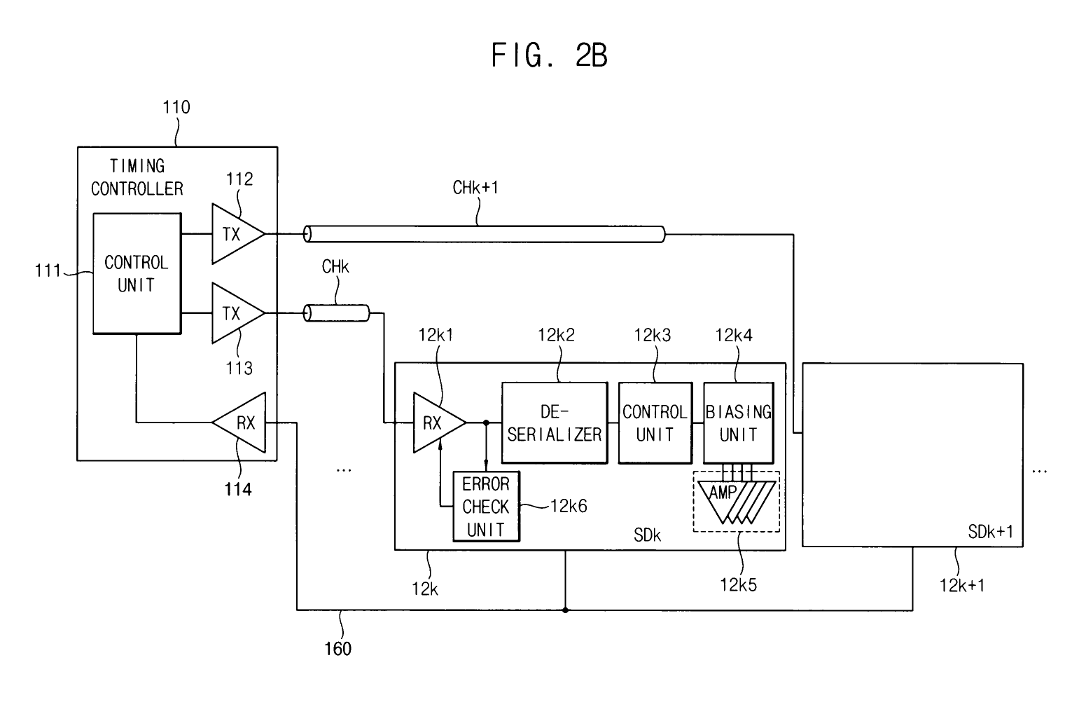

The timing controller 100 may transfer display data TD including image data, control data and clock signals through signal lines 151˜15n to the source drivers 121˜12n. During a first period of an initialization period, the timing controller 110 may transmit clock training signals to the source drivers 121˜12n such that a clock recovery unit 132 (refer to FIG. 2) is in a locked state (e.g., outputs a clock signal that is synchronized with an incoming data signal). During a second period of the initialization period, which follows the first period, the timing controller 100 may transmit test patterns repeatedly to the source drivers 121˜12n for adjusting configuration data (e.g., for determining appropriate levels, such as voltage levels, of the configuration data) for controlling each of the source drivers 121˜12n. Each of the source drivers 121˜12n may perform tests based on the test patterns, and may transmit to the timing controller 110 a ready signal RDY (refer to FIG. 2) indicating whether each of the source drivers 121˜12n is ready to operate or not.

During a data transfer period, the timing controller 100 may transmit to the source drivers 121˜12n data corresponding to each line of one of more image frames. The data may include data bits and a clock code which is periodically appended to the data bits. In one embodiment, the clock code may be appended to the data bits with same period as a period of the clock training signal.

During a vertical blank period, the timing controller 100 may transmit at least a modulated clock signal to the source drivers 121˜12n. The modulated clock signal may be generated by adjusting at least one of a rising edge and a falling edge of the clock training signal. In addition, during a first period of the vertical blank period, the timing controller 100 may transmit the modulated clock signal to the source drivers 121-12n, and during a second period of the vertical blank period following the first period, the timing controller 110 may transmit test patterns repeatedly to the source drivers 121˜12n for determining whether each of the source drivers 121˜12n is ready to operate or not. In addition, during the first period of the vertical blank period, the timing controller 100 may transmit test patterns repeatedly to the source drivers 121˜12n for determining whether each of the source drivers 121˜12n is ready to operate or not, and during the second period of the vertical blank period following the first period, the timing controller 110 may transmit the modulated clock signal to the source drivers 121˜12n.

The source drivers 121-12n are connected to the timing controller 110 through the signal lines 151˜15n respectively. In one embodiment, the source drivers 121˜12n are point-to point connected to the timing controller 110 through the signal lines 151˜15n. The source drivers 121˜12n receive the display data TD from the timing controller 110 through the signal lines 151˜15n respectively.

In addition, the source drivers 121˜12n may transmit to the timing controller 110 the ready signal and a soft fail information through a backward signal line 160, which may be a separate signal path from the path through which the timing controller 110 sends test signals to the source drivers 121˜12n. For example, the source drivers 121˜12n may inform the timing controller 110 of the soft-fail when the clock recovery unit 132 is not locked or when settings data of the source drivers 121˜12n are changed due to electrostatic discharge (ESD). In addition, through the backward signal line 160, also referred to herein as a return signal line 160, the source drivers 121˜12n inform the timing controller 110 of the ready information indicating the level at which the errors do not occur after the source drivers 121˜12n perform test based on the test pattern which is repeatedly transmitted from the timing controller 110. Stated in another way, during testing, it may be determined that errors occur when a voltage level of signals used in a source driver is certain value, and the errors continue to occur as that value increases or decreases (for example, due to an adjustment made in the driver to change the voltage level). However, after a certain point of the voltage levels increasing or decreasing, errors no longer occur. At this point, for each source driver, the source driver can send a signal to the timing controller 110 indicating that the source driver is ready.

The backward signal line 160 may be a shared back channel (SBC) which is shared by the source drivers 121˜12n. In an embodiment, the timing controller 110 and the source drivers 121˜12n are connected to each other through the backward signal line 160 in a multi-drop topology as illustrated in FIG. 1. In another embodiment, the timing controller 110 and the source drivers 121˜12n are connected to each other through the backward signal line 160 in a daisy chain topology.

FIG. 2A is a block diagram illustrating one of the source drivers in FIG. 1 according to example embodiments.

In FIG. 2A, the source driver 121 is illustrated, and other source drivers 122˜12n may be substantially the same as the source driver 121.

The source driver 121 may include a receiver 131, a clock recovery unit 132, a deserializer 133, a data latch unit 134, a data converting unit 135, a control unit 136, a biasing unit 137, an amplifying unit 138, a configuration register 139 and an error check unit 140, each of which includes circuitry such as transistors, capacitors, logic gates, and other circuit elements to implement certain functionality described in more detail below.

The receiver 131 receives the display data TD, converts a level (e.g., a signal voltage level) of the display data TD to a transistor-transistor logic (TTL) level, and provides the converted data signal to the clock recovery unit 132. During the first period of the initialization period, the clock recovery unit 132 may receive the display data TD and may generate a recovered clock signal from the display data TD. In one embodiment, for example, the clock recovery unit 132 may include a delay-locked loop (DLL) or a phase-locked loop (PLL). When the clock recovery unit 132 is in a locked state, and during the second period of the initialization period, the timing controller 110 may repeatedly transmit to the source driver 121 the test pattern as the display data TD for determining a setting of the receiver 131 of the source driver 121 to control the voltage level conversion by the receiver 131 (e.g., the conversion may refer to a conversion from a voltage level of an external signal to a voltage level of the TTL signal output from the receiver). The test pattern, transmitted as the display data TD, may be transferred to the error check unit 140 through the receiver 131. The error check unit 140 may check whether an error occurs or not, for example, by determining and indicating whether the voltage level of the test pattern is attenuated or not during transmission through the signal line 151. For example, the error check unit 140 may determine whether an error occurs by comparing the level of the test pattern with a reference level. For example, a comparator in the error check unit 140 may compare the voltage level of the test pattern through the receiver 131 with the reference voltage level and may determine whether the error occurs based on the comparison result. In one embodiment, when the level of the test pattern output from the receiver 131 is lower than the reference level, the clock recovery unit 132 determines that the error occurs. In this embodiment, when the level of the test pattern output from the receiver 131 is equal to or higher than the reference level, the clock recovery unit 132 determines that the error does not occur. When the test pattern is repeatedly transmitted to the error check unit 140, the error check unit 140 may provide the receiver 131 with notifying signal NS with a low logic level (e.g., “0”) when the level of the test pattern is lower than the reference level after comparing the level of the test pattern with the reference level. The low level notifying signal therefore indicates that the voltage level of signals output from the receiver 131 are lower than a desired reference level, so when the receiver 131 receives the notifying signal NS with a low level, the receiver 131 may adjust a setting of the receiver 131 to increase the voltage level of the test pattern output from the receiver 131 to provide the level-increased test pattern to the error check unit 140. When the receiver 131 receives the notifying signal NS with a high logic level (e.g., “1”), the receiver 131 may maintain settings of the receiver 131 to maintain the level of the test pattern output from the receiver 131. In one embodiment, the configuration register 139 may provide the reference level to the error check unit 140. The error check unit 140 may increase the level of the test pattern for each subsequent test pattern by increasing the output level (also referred to herein as the receiving level) of the receiver 131 for each subsequent test pattern until the error does not occur due to a particular test pattern.

In one embodiment, the error check unit 140 may provide the receiver 131 with notifying signal NS with a high logic level when the level of the test pattern is higher than the reference level after comparing the level of the test pattern with the reference level.

In one embodiment, when the test pattern is repeatedly transmitted to the error check unit 140, the error check unit 140 may provide the receiver 131 with notifying signal NS with a high level when the level of the test pattern is higher than the reference level after comparing the level of the test pattern with the reference level. When the receiver 131 receives the notifying signal NS with a high level, the receiver 131 may decrease the level of the test pattern to provide the level-decreased test pattern to the error check unit 140 by decreasing the receiving level of the receiver 131. In this example, the error check unit 140 detects an error when the level of the test pattern is higher than the reference level. For example, the error check unit 140 may decrease the level of the test pattern by decreasing the receiving level of the receiver 131 until the error does not occur due to the test pattern.

In another embodiment, when the test pattern is repeatedly transmitted to the error check unit 140, the error check unit 140 may adjust the receiving level of the receiver 131 such that the level of the test pattern is gradually increased, and the receiver 131 has a receiving level equal to or higher than the level at which the error does not occur due to the received test pattern. In this example, the error check unit 140 detects an error when the level of the test pattern is lower than the reference level.

In one embodiment, the error check unit 140 may adjust the output level of the receiver 131 by adjusting receiver 131 settings such as a bias current or a termination resistor of the receiver 131. In addition, after the receiving level of the receiver 131 is set based on the test of the test pattern, during the data transfer period, the source driver 121 may receive configuration data for configuring other portions of the source driver, and the configuration data will be output from the receiver 131 at adjusted levels based on the adjusted receiver 131 settings.

In one embodiment, during the second period of the initialization period, the error check unit 140 performs test based on the repeated-received test pattern, adjusts the receiving level of the receiver 131 such that receiver 131 has an output voltage level equal to or higher than the first voltage level at which the error does not occur due to the received test pattern, and outputs the ready signal RDY indicating whether the source driver 121 is ready to operate or not. The ready signal RDY is provided to the timing controller 121 through the backward signal line 160 as the ready state information.

When the clock recovery unit 132 is locked and it is determined that no error occurs in the test signals, the error check unit 140 informs the timing controller 110 the source driver 121 is ready to receive data by outputting the ready signal RDY. During the data transfer period, the clock recovery unit 132 may recover the recovered clock signal from the display data TD by detecting an edge between the clock code and data bits adjacent to the clock code. In addition, the clock recovery unit 132 may generate multi-phased clock signal based on the recovered clock signal and provide the data bits and the multi-phased clock signal to the deserializer 133 during the data transfer period.

The deserializer 134 may deserialize the data bits based on the multi-phased clock signal. The deserializer 134 may provide digital data associated with image data of the deserialized digital data to the data latch unit 134, and may provide the control unit 136 and the configuration register 139 with the configuration data for controlling the source driver 121 of the deserialized digital data. The data latch unit 134 may store the digital data associated with image data of the deserialized digital data. The data latch unit 134 may include a shift register. The data latch unit 134 may store the digital data associated with image data while shifting the digital data associated with image data. When the data latch unit 134 stores digital data corresponding to one row of pixels included in the display panel 170, the data latch unit 134 may provide the stored digital data to the data converting unit 135. The data converting unit 135 then generates analog voltages by selecting grey voltages based on the digital data from the data latch unit 134 and provides the analog voltages to the amplifying unit 138. The amplifying unit 138 then amplifies the analog voltages to provide the amplified analog voltages to the display panel 170. In one embodiment, the amplifying unit 138 includes a plurality of amplifiers, and the bias unit 137 may control the bias of the amplifiers under control of the control unit 136. As a result, the control unit 136 and the bias unit 137 may control the bias of the amplified analog voltages that will be provided to the display panel 170.

The display panel 170 may be operated by the source drivers 121˜12n to display an image. For example, the display panel 170 may include a liquid crystal display panel, an organic light emitting display panel, a plasma display panel and/or etc. The display device 100 may further include a gray scale voltage generator that provides gray scale voltages to the source drivers 121˜12n and gate drivers that select a row of pixels in the display panel 1300.

As described above, the timing controller 110 may repeatedly transmit the test patterns for adjusting the settings of the receiver, which determines the level at which configuration data for controlling the source drivers 121˜12n is output from the receiver, and each source driver may individually adjust a receiving level of its receiver during the second period of the initialization period. Each of the source drivers 121˜12n may use the configuration data output from its receiver at respective adjusted receiving level, and each of the source drivers 121˜12n may operate based on respective configuration data depending on each channel characteristic.

Therefore, power consumption of the display device 100 may be reduced.

In addition, the display device 100 may reduce an electromagnetic interference (EMI) by the timing controller 110 transmitting the modulated clock signal to the source drivers 121˜12n during the vertical blank period. Further, the display device 100 may reduce a power consumption by the timing controller 110 receiving the soft fail information and the ready state information from the respective source drivers 121˜12n through the backward signal line 160, recovering efficiently the soft fail and transferring the configuration data adjusted by the receiver settings to the respective source drivers 121˜12n such that the different channel characteristics of the different source drivers 121˜12n are accounted for.

FIG. 2B illustrates a portion of the display device of FIG. 1, according to one exemplary embodiment.

Referring to FIG. 2B, the timing controller 110 and source drivers 12k and 12k+1 are illustrated. The timing controller 110 is connected to the source driver 12k through a channel CHk, and the timing controller 110 is connected to the source driver 12k+1 through a channel CHk+1. In addition, the timing controller 110 is connected to the source drivers 12k and 12k+1 through the backward signal line 160.

The timing controller 110 may include a control unit 111, transmitters 112 and 113 and a receiver 114. The source driver 12k may include a receiver 12k1, a de-serializer 12k2, a control unit 12k3, a biasing unit 12k4, an amplifying unit 12k5, and an error check unit 12k6. Although not illustrated, configuration of the source driver 12k+1 may be substantially the same as configuration of the source driver 12k. The transmitter 113 is connected to the source driver 12k through the channel CHk, and transmitter 112 is connected to the source driver 12k+1 through the channel CHk+1. Since the channels CHk and CHk+1 may have different physical characteristics such as channel length, the source drivers 12k and 12k+1 may receive different levels of data (e.g., data having different voltage levels) when the timing controller 110 transmits same data to the source drivers 12k and 12k+1. For controlling the source drivers 12k and 12k+1 using optimum levels for configuration data that account for the different physical characteristics of channels and each state of the source drivers 12k and 12k+1, optimized receiver output levels can be determined. For example, in one embodiment, to determine an optimized receiver output level, the timing controller 110 repeatedly transmits the test pattern to the source drivers 12k and 12k+1, the error check unit 12k6 performs testing based on the test pattern and adjusts the receiving level (i.e., output level) of the receiver 12k1 to a level equal to or higher than a level at which the error does not occur due to the test pattern. The receiver 12k1 in the source driver 12k and a receiver in the source driver 12k+1 may have different output levels initially during the initialization period based on their initial settings and due to the different channel characteristics. However, these settings may be adjusted by different amounts based on the error checking and testing during the initialization period such that the outputs of the two receivers are substantially the same after the adjustment. As a result, the source drivers 12k and 12k+1 respectively receive configuration data for configuring the drivers based on the adjusted settings, and respectively operate based on the adjusted configuration data at a level adjusted by the receiver during the data transfer period.

In FIG. 2B, the source drivers 12k and 12k+1 may transmit to the timing controller 110 the soft fail information or the ready state information of the source drivers 12k and 12k+1 through the backward signal line 160.

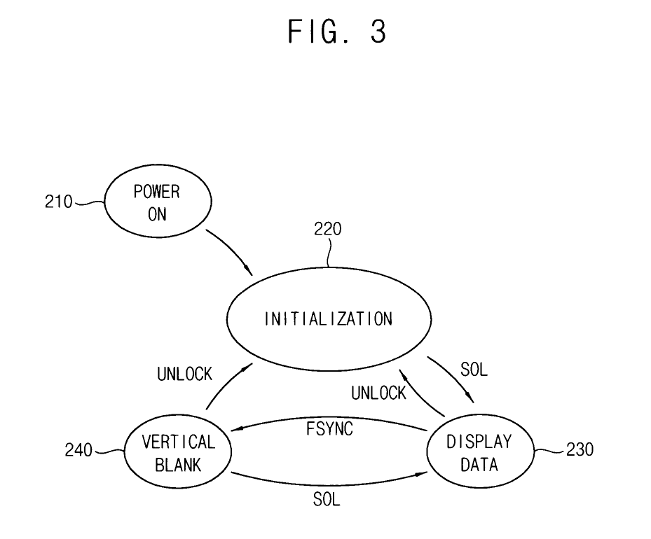

FIG. 3 is a state diagram illustrating an example of operating modes of a display device illustrated in FIG. 1, according to one exemplary embodiment.

Referring to FIGS. 1 and 3, if a display device 100 is powered on S210, the display device 100 operates in an initialization mode S220. The display device 100 operates in the initialization mode S220 during an initialization period. The initialization mode S220 may include an initial training mode and a test mode. In the initial training mode, the timing controller 110 may transmit clock training signals to the source drivers 121˜12n such that the clock recovery unit 132 (refer to FIG. 2) becomes locked. In the test mode, the timing controller 110 may transmit test patterns repeatedly to the source drivers 121˜12n for testing each state of the source drivers 121˜12n and adjusting the receiving level of the receiver, which determines the level at which configuration data for controlling each of the source drivers 121˜12n will be applied to the source drivers.

After the clock recovery unit 132 is locked and the source drivers 121˜12n no longer have any errors, the display device 100 operates in a display data mode S230. The timing controller 110 may inform the source drivers 121˜12n of a start of the display data mode S230 by transmitting data including a line start field SOL to the source drivers 121˜12n. The display device 100 may operate in the display data mode S230 during a data transfer period of an image frame. In the display data mode S230, the timing controller 110 may transfer data packets respectively corresponding to lines of the image frame to the source drivers 121˜12n.

In one embodiment, after image data of an image frame are transferred, the display device 100 operates in a vertical training mode until image data of a next image frame are transferred. The timing controller 110 may inform the source drivers 121˜12n of an end of the display data mode S230 by transmitting data including a frame synchronization signal FSYNC to the source drivers 121˜12n. The display device 100 may operate in a vertical training mode during the vertical blank mode S240. In the vertical blank mode S240, the timing controller 110 may transmit a modulated clock signal to the source drivers 121˜12n. In addition, the display device 100 may operate in a vertical training mode and a test mode during the vertical blank mode S240. That is, the vertical blank mode S240 may include the vertical training mode and test mode. During the test mode, test signals may be repeatedly sent to the source drivers 121˜12n in order to set the respective receivers at optimum levels, as described above.

The display data mode S230 and the vertical blank mode S240 may be performed per image frame. The display data mode S230 and the vertical blank mode S240 may be repeatedly performed until the display device 100 is powered off or until the source drivers 121˜12n are unlocked such that they become out of phase (e.g., by a soft fail). When an operating mode of the display device 100 changes from the vertical blank mode S240 to the display data mode S230, the timing controller 110 may transfer the data including the line start field SOL to the source drivers 121˜12n. When the operating mode of the display device 100 changes from the display data mode S230 to the vertical blank mode S240, the timing controller 110 may transfer the data including the frame synchronization signal FSYNC to the source drivers 121˜12n.

If the source drivers 121˜12n are unlocked (e.g., by a soft fail) while the display data mode S230 or the vertical blank mode S240 is performed, the display device 100 may operate again in the initialization mode S220. In the initial training mode of the initialization mode S220, the timing controller 110 may transmit the clock training signal to the source drivers 121˜12n and the clock recovery unit 132 becomes locked based on the clock training signal. In the initial training mode of the initialization mode S220, the source drivers 121˜12n may re-initialize the setting data which was changed by the soft fail. In addition, in the test mode of the initialization mode S220, the timing controller 110 may transmit test patterns repeatedly to the source drivers 121˜12n for testing each state of the source drivers 121˜12n and adjusting the receiving level of the receiver, which determines the level at which configuration data for controlling each of the source drivers 121˜12n will be output from the source driver receivers.

As described above, the display device 100 operates in the initialization mode S220 including the initial training mode and the test mode, the display data mode S230, and the vertical blank mode S240 including at least the vertical training mode. Therefore, the display device 100 may employ the intra-panel interface.

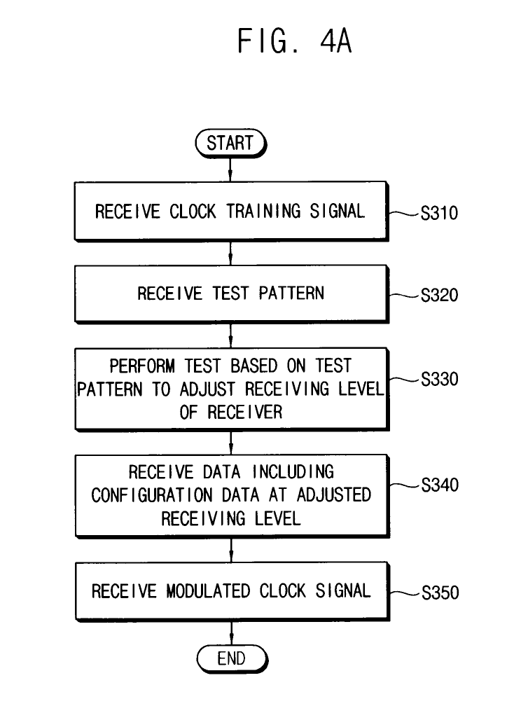

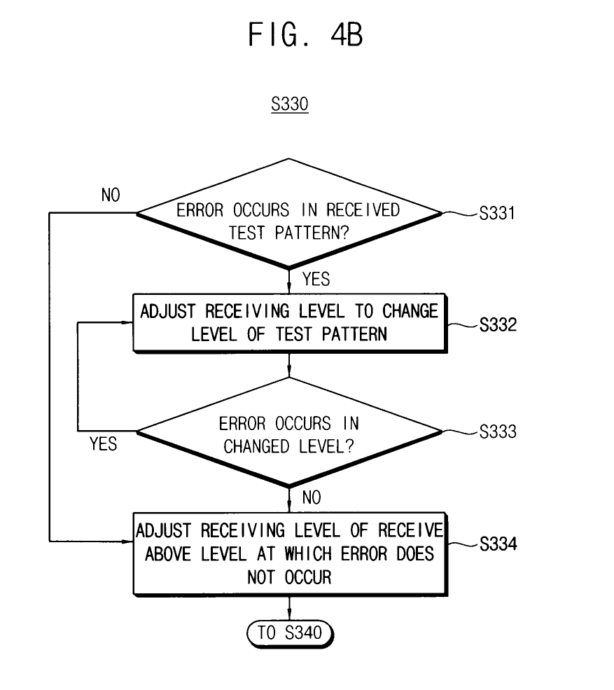

FIG. 4A is a flow chart illustrating a method of transferring data in a display device of FIG. 1, according to one exemplary embodiment.

Referring to FIGS. 1, 2A, 2B and 4A, the source drivers 121˜12n receive a clock training signal from the timing controller 110 such that the clock recovery unit 132 of the source drivers 121˜12n are locked during a first period of the initialization period (310). For example, the timing controller 110 may transmit the clock training signal when the display device 100 is powered on or after a soft fail occurs in the source drivers 121˜12n. The source drivers 121˜12n may be stabilized in response to the clock training signal. For example, the clock recovery unit 132 in each of the source drivers 121˜12n may be locked in response to the clock training signal, and settings values of the source drivers 121˜12n may be initialized. After the clock recovery unit 132 in each of the source drivers 121˜12n is locked, and the settings values of the source drivers 121˜12n are initialized, the source drivers 121˜12n receive test patterns repeatedly from the timing controller 110 for testing each state of the source drivers 121˜12n and adjusting the settings of the receiver, which determines the levels of the configuration data used for controlling each of the source drivers 121˜12n (S320). When the source drivers 121˜12n receive the test pattern, the error check unit 140 in each of the source drivers 121˜12n performs testing based on the test pattern and adjusts the output level of the receiver 131 to a level at which the error does not occur (S330). The source drivers 121˜12n receive respective configuration data at adjusted levels depending on the adjusted output levels of the receiver, and thus, the source drivers 121˜12n operate based on the respective configuration data that accounts for the different physical characteristics of channels and each state of the source drivers 121˜12n. Therefore, the display device 100 may reduce the power consumption.

During the data transfer period, the source drivers 121˜12n receive respective data including configuration data, corresponding to each line of the image frame at the adjusted receiving level of the receiver 131 from the timing controller 110 (S340). The data may include data bits and clock codes periodically inserted into the data bits. The clock recovery unit 132 may generate a recovered clock signal by detecting an edge between each clock code and a data bit adjacent to the clock code. The source drivers 121˜12n may sample the data bits based on the recovered clock signal, and may drive a display panel 170 based on the sampled data bits.

In one embodiment, during the vertical blank period, the source drivers 121˜12n receive at least a modulated clock signal from the timing controller 110 (S350). The modulated clock signal may be generated by adjusting at least one of a rising edge and a falling edge of the clock training signal. In some embodiments, in the vertical blank mode, the timing controller 110 may transmit the clock training signal without the modulation during a predetermined time before the display data mode starts. During a first period of the vertical blank period, the timing controller 100 may transmit the modulated clock signal to the source drivers 121˜12n, and during a second period of the vertical blank period, the timing controller 100 may transmit a clock training signal and may transmit test patterns to the source drivers 121˜12n, similar to the clock training signal and test patterns transmitted during the second period of the initialization period. In addition, or alternatively, during the first period of the vertical blank period, the timing controller 100 may transmit a clock training signal and test patterns to the source drivers 121˜12n, and during the second period of the vertical blank period, the timing controller 110 may transmit the modulated clock signal to the source drivers 121˜12n.

Data transmission and the modulated clock signal transmission may be repeated at every image frame. The source drivers 121˜12n may provide lock state information to the timing controller 110 through a backward signal line 160 when the soft fail occurs in the source drivers 121˜12n during the data transmission and the modulated clock signal transmission. In some embodiments, the source drivers 121˜12n may change a voltage of the backward signal line 160 to provide the lock state information. In other embodiments, the timing controller 110 may provide order information to the source drivers 121˜12n, and the source drivers 121˜12n may provide the lock state information during response times indicated by the order information, respectively. When the timing controller 110 receives from the source drivers 121˜12n the lock state information indicating that the soft fail occurs in the source drivers 121˜12n, the timing controller 110 transmits the test pattern to source drivers 121˜12n after transmitting the clock training signal to the source drivers 121˜12n or the source driver of the source drivers 121˜12n where the error occurs.

FIG. 4B is a flow chart illustrating the step S330 in FIG. 4A, according to one exemplary embodiment.

Referring to FIGS. 1, 2A, 2B and 4B, the error check unit 140 may perform the test based on the test pattern and may check whether the error occurs due to the received test pattern during a reference internal (S331). When the error occurs due to the received test pattern during a reference internal (YES in S331), the error check unit 140 adjusts the receiving level of the receiver 131 to change the level of the test pattern provided to the error check unit 140 (S332).

When an initial level of the test pattern is the highest (maximum) level, which may be higher than necessary and thus may unnecessarily drain extra power, the error check unit 140 may adjust the receiving level of the receiver 131 to decrease the level of the test pattern output from the receiver 131. When the initial level of the test pattern is the lowest (minimum) level, or a low enough level such that an error occurs, the error check unit 140 may adjust the receiving level of the receiver 131 to increase the level of the test pattern output from the receiver 131. The error check unit 140 performs the test of the next test pattern based on the adjusted receiver 131, and checks whether the error occurs at the level-changed test pattern (S333). When the error occurs at the level-changed test pattern (YES in S333), the error check unit 140 adjusts the receiving level of the receiver 131 to further change the level of the test pattern (S332). This may be repeated such that the error check unit 140 may gradually increase the level of the test pattern by adjusting the receiving level of the receiver 131 until the error does not occur. The steps (S332 and S333) may constitute a loop and the error check unit 140 may check whether the error occurs at a given level during the reference interval. In addition, the error check unit 140 may adjust the receiving level of the receiver 131 to increase the level of the test pattern to a next level when the error occurs at the given level during the reference interval. When the error does not occur at the level of the received test pattern (NO in S331) or the error does not occur at the level-changed test pattern (NO in S333), the error check unit 140 may adjust (or fix) the receiving level of the receiver 131 at a level equal to or higher than the level at which the error does not occur.

In other embodiments, if the output of the receiver 131 is initially higher than it needs to be to properly drive the source driver to which it is connected, the error check unit 140 may gradually decrease the level of the test pattern by adjusting the receiving level of the receiver 131 until the error does occur due to the received test pattern during the reference interval. At that point, when the error occurs at the decreased-level of the test pattern, the error check unit 140 may adjust (or fix) the receiving level of the receiver 131 to a level higher than the level at which the error occurs. As such, to achieve an optimum receiver output level, the source drivers can be set so that the receiver output level is just high enough to avoid errors, but as low as possible above that to avoid extra power consumption.

When the receiving level of the receiver 131 is fixed at a level equal to or higher than the lowest level at which the error does not occur, the source drivers 121˜12n receive respective configuration data, as output for example from their respective receivers, at the adjusted level. As s result, the source drivers 121˜12n operate based on the respective configuration data having adjusted levels depending on the different physical characteristics of channels and each state of the source drivers 121˜12n, even though the timing controller 110 transmits same data to the source drivers 121˜12n during the data transfer period. As such, the different source drivers 121˜12n have different settings based on individual self-testing that accounts for different channel characteristics. Therefore, the display device 100 may reduce the power consumption.

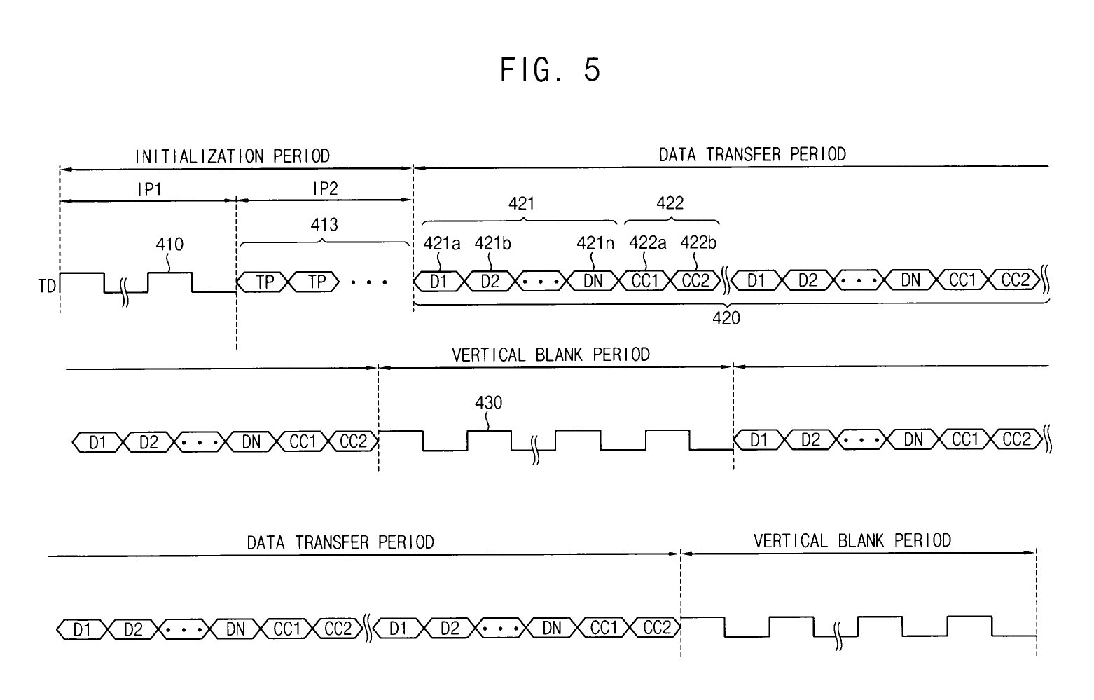

FIG. 5 is a diagram illustrating signals transferred in a display device of FIG. 1, according to one exemplary embodiment.

Referring to FIGS. 1 and 5, the timing controller 110 may transmit a clock training signal 410 to source drivers 121˜12n during a first period IP1 of the initialization period. The timing controller 110 may repeatedly transmit the test pattern (TP) 413 during a second period IP2 of the initialization period. The first period may have a first predetermined duration of time, and the second period may have a second predetermined duration of time. Alternatively, the first period may have a duration that is based on the amount of time needed for the clock recovery unit 132 to be in a locked state, and the second period may have a duration based on the amount of time needed for the receivers of the source drivers 121˜12n to achieve optimum operating levels. Other durations for the first and second periods may be used. The timing controller 110 may transfer data respectively corresponding to lines of an image frame to the source drivers 121˜12n in the data transfer period. A data 420 may include a plurality of data bits 421 and a clock code 422 periodically inserted into the data bits 421. The clock code 422 may be appended per N data bits 421a, 421b and 421n, where N is an integer more than 1. In some embodiments, as illustrated in FIG. 5, the clock code 422 may have two bits including a first bit 422a and a second bit 422b. In other embodiments, the clock code 422 may have one bit. After the data in the image frame are transferred, the timing controller 110 may transmit a modulated clock signal 430 to the source drivers 121˜12n in a vertical blank period. The modulated clock signal 430 may be generated by adjusting at least one of a rising edge or a falling edge of the clock training signal. After the vertical blank period, data for a next image frame may be transferred in a next display data mode. The data transfer period and the vertical blank period may be repeated.

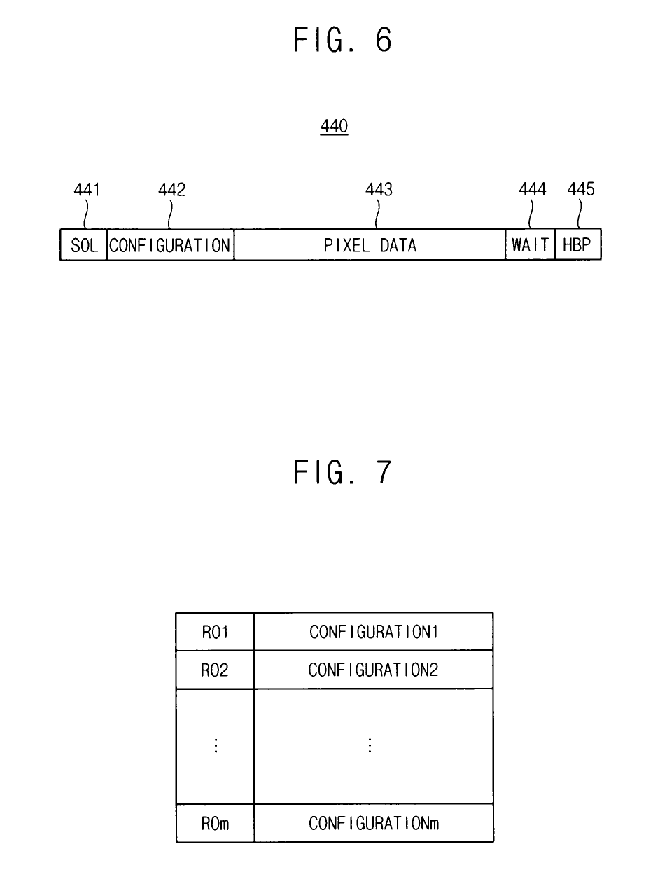

FIG. 6 is a diagram illustrating a data corresponding to one line of an image frame during a data transfer period, according to one exemplary embodiment.

Referring to FIG. 6, a data 440 transferred during the data transfer period includes a line start field 441, a configuration field 442, a pixel data field 443, a wait field 444 and a horizontal blank field 445.

The line start field 441 indicates a start of each line of an image frame. A source driver may operate an internal counter in response to the line start field 441, and may identify the configuration field 442, the pixel data field 443 and the wait field 444 based on a counting result of the internal counter. The line start field 441 may include a clock code having a specific edge or pattern to be distinguished from the horizontal blank field 445 of a previous line or from a vertical blank period of a previous image frame.

The configuration field 442 may include configuration data for controlling the source driver. Since the configuration data are written in the configuration field 442, a display device 100 of FIG. 1 may not require a line for transmitting a control signal. When a data corresponding to a last line of an image frame is transferred, the configuration data written in the configuration field 442 of the data may include a frame synchronization signal. The source driver may know that a vertical training mode is to be started by receiving the frame synchronization signal written in the configuration field 442. The configuration data may further include driver setting values, such as a bias value, equalization value, termination resistor value of the receiver, etc., for certain parts of the source driver. The configuration data may further include the bias information for controlling the bias of amplifiers in the amplifying unit 138. The bias information for controlling the bias of amplifiers in the amplifying unit 139 may be included in different configuration field from the configuration field where the driver setting values, such as the bias value, the equalization value, the termination resistor value of the receiver, etc., are included. In some embodiments, the configuration data may further include a configuration update bit that indicates whether the configuration data is updated. For example, the source driver may not process the configuration data written in the configuration field 442 if the configuration update bit has a logic low level, and may change the driver setting values based on the configuration data if the configuration update bit has a logic high level.

The pixel data field 443 includes image data. The source driver may receive the image data written in the pixel data field 443, and may drive the display panel to display an image based on the image data. The wait field 444 is assigned for the source driver to have an enough time to receive and to store the image data. In some embodiments, data bits in the pixel data field 443 and the wait field 444 may be scrambled, and the source driver may recover the image data by descrambling the scrambled data bits. An EMI may be reduced by transferring the scrambled data bits in the pixel data field 443 and the wait field 444.

The horizontal blank field 445 is assigned for the source driver to have an enough time to drive the display panel based on the image data. For example, the horizontal blank field 445 may have a bit length corresponding to a time when the image data stored in a data latch unit are converted in analog voltages and are applied to the display panel. The horizontal blank field 445 may have an edge of a predetermined direction or may have a clock code of a predetermined pattern to be distinguished from the line start filed 441.

FIG. 7 is a table illustrating a relationship between the receiver levels and the configuration data in FIG. 6, according to one exemplary embodiment.

In FIG. 7, the receiver levels RO1˜ROm represent the levels of the signals output from the receiver based on an input test signal when the receiving level of the receiver 131 is adjusted by the error check unit 140. For example, when a test pattern is received, level RO1 represents a receiver 131 output level for a first receiver settings, and level RO2 represents a receiver 131 output level for a second receiver settings, etc.

Referring to FIG. 7, during testing, each output level RO1˜ROm is related to each level of the configuration data CONFIGURATION1˜CONFIGURATIONm. For example, a first test pattern RO1 is converted by a receiver having first settings to have a first output voltage level. Based on the first output voltage level, a corresponding first set of configuration levels for the configuration data are used by the source driver. A second test pattern RO2 is converted by a receiver having second settings to have a second output voltage level. Based on the second output voltage level, a corresponding second set of configuration levels for the configuration data are used by the source driver. As a result, if the testing and setting procedure for the receivers 131 described above were not used to correct for errors due to channel characteristics, even when the same configuration settings were transmitted from the timing controller for each source driver, the source drivers might use different configuration levels due to the different channel characteristics affecting the output of the receivers 131. For example, a first source driver 121 may use first levels of configuration data CONFIGURATION 1, and a second source driver 122 may use second levels of configuration data CONFIGURATION 2, etc.

In such a system, some source drivers may have erroneous configuration data, and others may use correct configuration data, but some of those that use correct configuration data may consume unnecessary amounts of power. To avoid this problem, the disclosed embodiments provide error checking individually by each source driver that compensates for variations in the channel characteristics. As a result, a more consistent, optimized output voltage can be output from each of the receivers of the source drivers, reducing power consumption while ensuring that erroneous configuration settings do not occur.

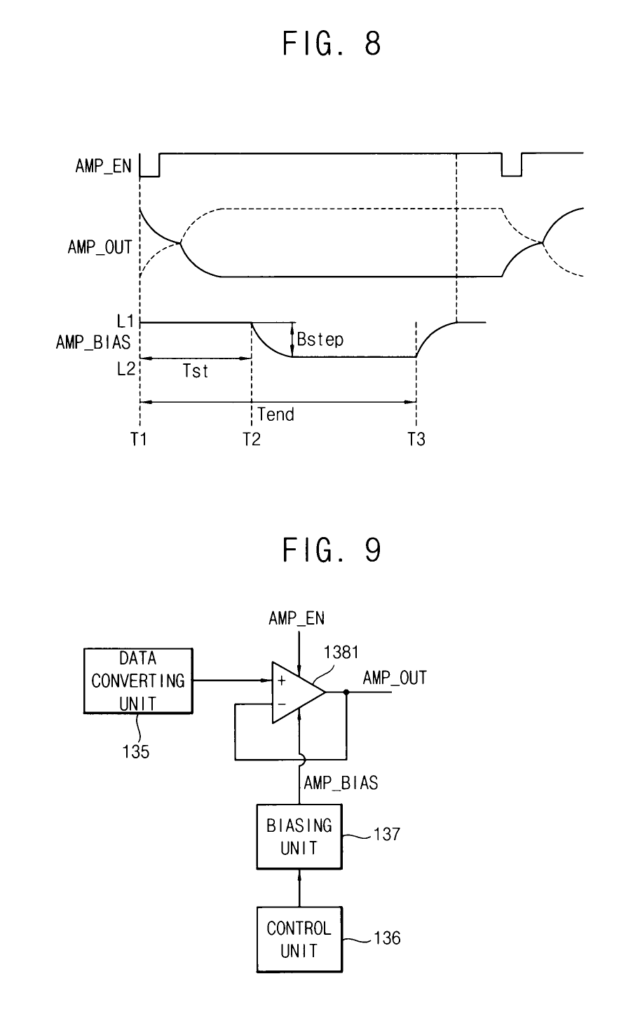

FIG. 8 illustrates an exemplary output of one of the amplifiers in the amplifying unit in FIG. 3 according to the bias information included in the configuration filed in FIG. 6.

FIG. 9 illustrates one of the amplifiers in the amplifying unit in FIG. 3, according to an exemplary embodiment.

In FIG. 9, the data converting unit 135, the control unit 136 and the bias unit 137 are also illustrated for convenience of explanation.

Referring to FIGS. 8 and 9, the bias information included in the configuration field 442 may include an applying interval Tst for applying a bias voltage AMP_BIAS with a first level L1, for stabilizing the amplified analog voltage AMP_OUT, which is output through the amplifier 1381, an amount of level change Bstep from the first level L1 to a second level L2 of bias voltage AMP BIAS after the amplified analog voltage AMP_OUT is stabilized and a starting point Tend of the level change of the bias voltage AMP_BIAS for being returned to the first level L1. At a time T1, the bias voltage AMP_BIAS with the first level L1 is applied to the amplifier 1381 in synchronization with an amp enable signal AMP_EN, and the bias voltage AMP_BIAS with the first level L1 is applied to the amplifier 1381 between the time T1 and a time T2. When the analog voltage AMP_OUT is stabilized, the level of the bias voltage AMP_BIAS is lowered at the time T2 to the second level L2. The bias voltage AMP_BIAS is maintained at the second level L2 at a time T3. The level of the bias voltage AMP BIAS is increased at the time T3 before the stabilized analog voltage AMP_OUT begins transition.

Referring to FIGS. 8 and 9, the amplifier 1381 is enabled in response to the amp enable signal AMP_EN. In addition, the bias voltage AMP_BIAS is adjusted in synchronization with a time when the analog voltage AMP_OUT is output from the amplifier 1381 which is enabled in response to the amp enable signal AMP_EN. Since the configuration field 442 includes the bias information for controlling the bias voltage, the power consumption may be reduced by adjusting the bias voltage AMP_BIAS provided to the amplifier according to an output state of the amplifier.

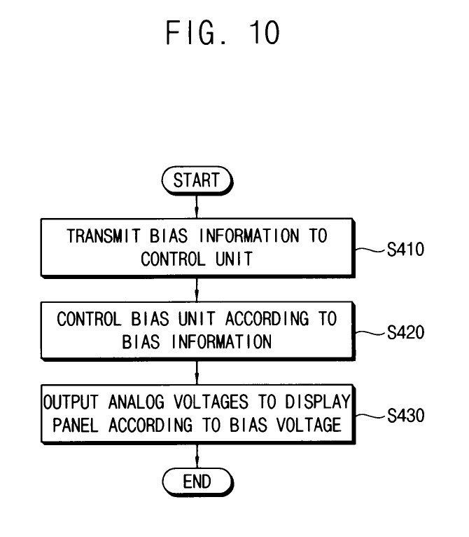

FIG. 10 is a flow chart illustrating a controlling a bias voltage of a source driver according to some embodiments.

Referring to FIGS. 1, 2A, 8, and 9, the timing controller 110 transfers to the control unit 136 configuration data including bias information for controlling a bias voltage of an amplifier 1381 (S410). The control unit 136 control a bias unit 137 according to the bias information, and the bias unit 137 provides the amplifier 138 with the bias voltage AMP_BIAS according to control of the control unit 136 (S420). The amplifier 1381 provides analog voltage to the display panel 170 according to the bias voltage AMP_BIAS from the bias unit 137 (S430). As described above, the bias information may include an applying interval Tst for applying a bias voltage AMP_BIAS with a first level L1, for stabilizing the amplified analog voltage AMP_OUT, which is output through the amplifier 1381, an amount of level change Bstep from the first level L1 to a second level L2 of bias voltage AMP_BIAS after the amplified analog voltage AMP_OUT is stabilized and a starting point Tend of the level change of the bias voltage AMP_BIAS for being returned to the first level L1.

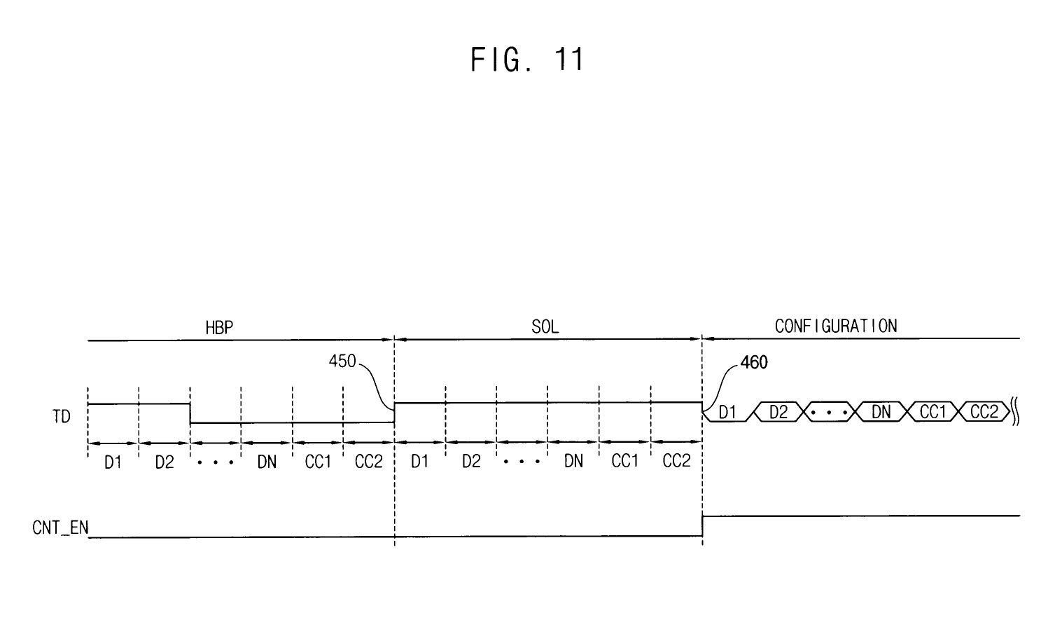

FIG. 11 is a diagram illustrating an example of a horizontal blank field and a line start field included in a data of FIG. 6, according to one embodiment.

Referring to FIG. 11, a horizontal blank field HBP includes a clock code having a rising edge 450, and a line start field SOL includes a clock code having a falling edge 460 that is different from the rising edge 450 of the clock code included in the horizontal blank field HBP. A source driver may identify the line start field SOL by detecting the falling edge 460 while a counter enable signal CNT_EN has a logic low level. The source driver may operate an internal counter by activating the counter enable signal CNT_EN at a logic low level, and may identify a configuration field, a pixel data field and a wait field based on a counting result of the internal counter. Although FIG. 27A illustrates an example where the horizontal blank field HBP includes the clock code have the rising edge 450 and the line start field SOL includes the clock code having the falling edge 460, each clock code of the horizontal blank field HBP may have a falling edge and the clock code of the line start field SOL may have a rising edge.

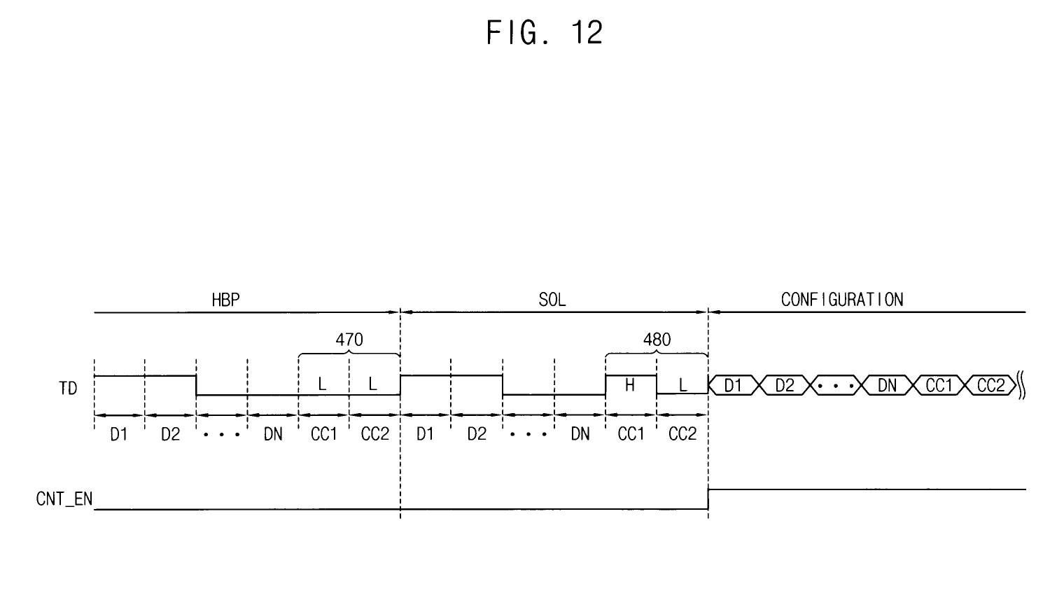

FIG. 12 is a diagram illustrating another example of a horizontal blank field and a line start field included in a data of FIG. 6, according to one embodiment.

Referring to FIG. 12, a horizontal blank field HBP includes a clock code having a predetermined pattern 470, and a line start field SOL includes a clock code having a pattern 480 that is different from the pattern 470 of the clock code included in the horizontal blank field HBP. For example, each clock code of the horizontal blank field HBP may have a first bit of a logic low level and a second bit of a logic low level, and the clock code of the line start field SOL may have a first bit of a logic high level and a second bit of a logic low level. A source driver may identify the line start field SOL by detecting the clock code having the first bit of the logic high level and the second bit of the logic low level.

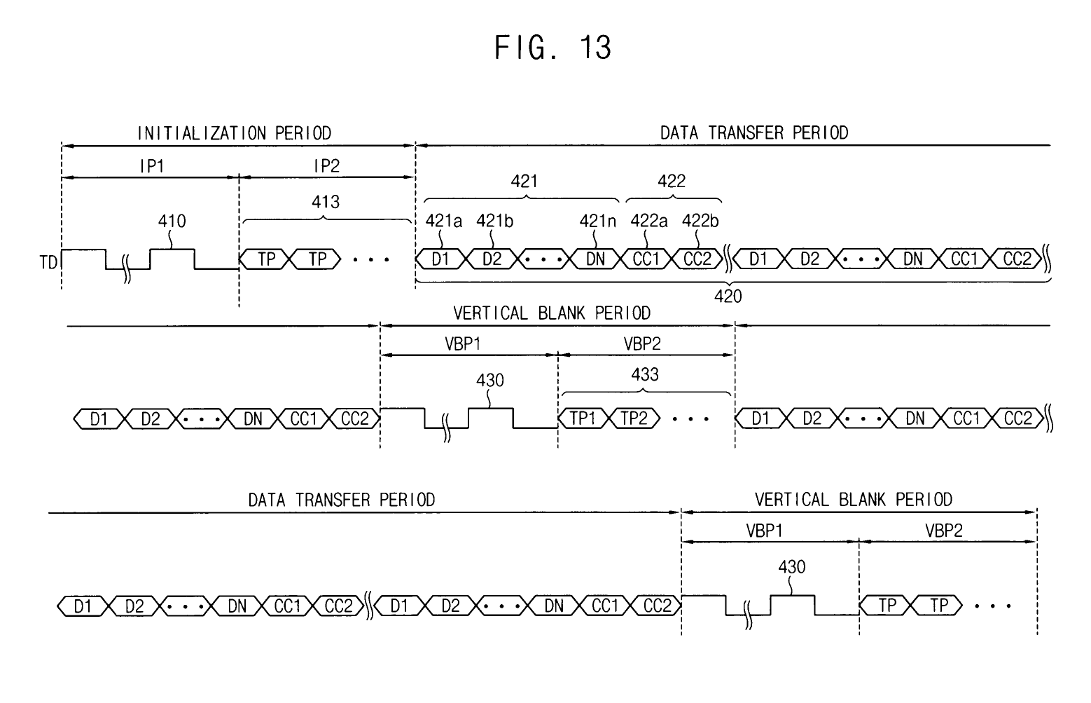

FIG. 13 is a diagram illustrating signals transferred in a display device of FIG. 1 according to some embodiments.

Example of FIG. 13 differs from the example of FIG. 5 in that the timing controller 110 may transmit the modulated clock signal 430 to the source drivers 121˜12n during a first period VBP1 of the vertical blank period, and the timing controller 110 may repeatedly transmit the test pattern 433 to the source drivers 121˜12n during a second period VBP2 of the vertical blank period. The timing controller 110 may test each of the source drivers 121˜12n and transfer configuration data to each of the source drivers 121˜12n according to receiver settings determined based on the test result at each frame.

FIG. 14 is a diagram illustrating signals transferred in a display device of FIG. 1 according to other embodiments.

Example of FIG. 14 differs from the example of FIG. 5 in that the timing controller 110 may repeatedly transmit the test pattern 433 to the source drivers 121˜12n during a first period VBP1 of the vertical blank period, and the timing controller 110 may transmit the modulated clock signal 430 to the source drivers 121˜12n during a second period VBP2 of the vertical blank period. That is, the timing controller 110 may test each of the source drivers 121˜12n and transfer configuration data to each of the source drivers 121˜12n according to receiver settings determined based on the test result at each frame.

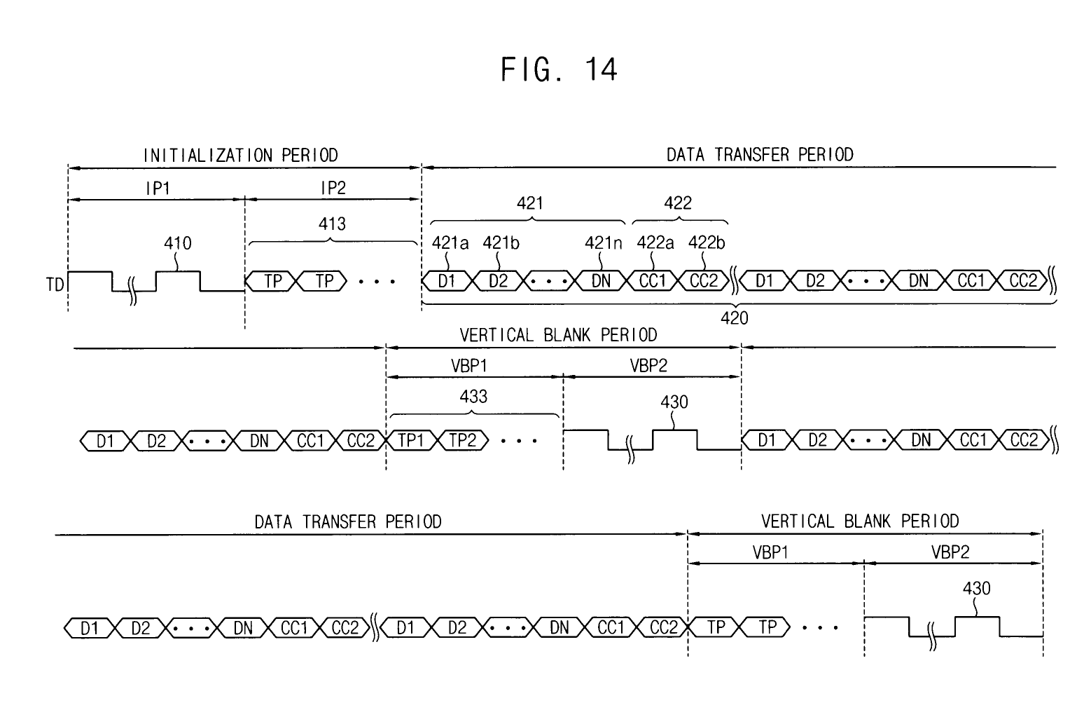

FIG. 15 is a diagram illustrating an example of a modulated clock signal transferred during a vertical blank period.

Referring to FIG. 15, a modulated clock signal may be generated by modulating rising edges 521, 522 and 523. For example, at least some of rising edges 521 and 522 of the modulated clock signal may have positions different from those of rising edges 511 and 512 of the clock training signal. In addition, some 523 of rising edges of the modulated clock signal may have position same as some 513 of rising edges of the clock training signal. Since the modulated clock signal is transferred, an EMI may be reduced.

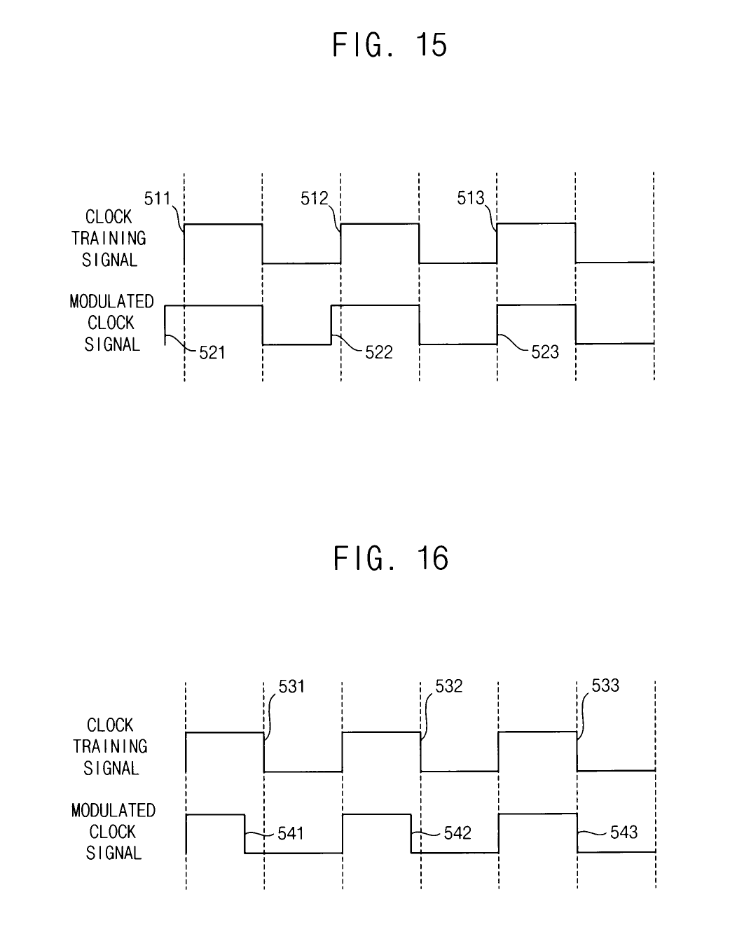

FIG. 16 is a diagram illustrating another example of a modulated clock signal transferred during a vertical blank period.

Referring to FIG. 16, a modulated clock signal may be generated by modulating falling edges 541, 542 and 543. For example, at least some of falling edges 541 and 542 of the modulated clock signal may have positions different from those of falling edges 531 and 532 of the clock training signal. In addition, some 543 of rising edges of the modulated clock signal may have position same as some 533 of rising edges of the clock training signal. Since the modulated clock signal is transferred, an EMI may be reduced.

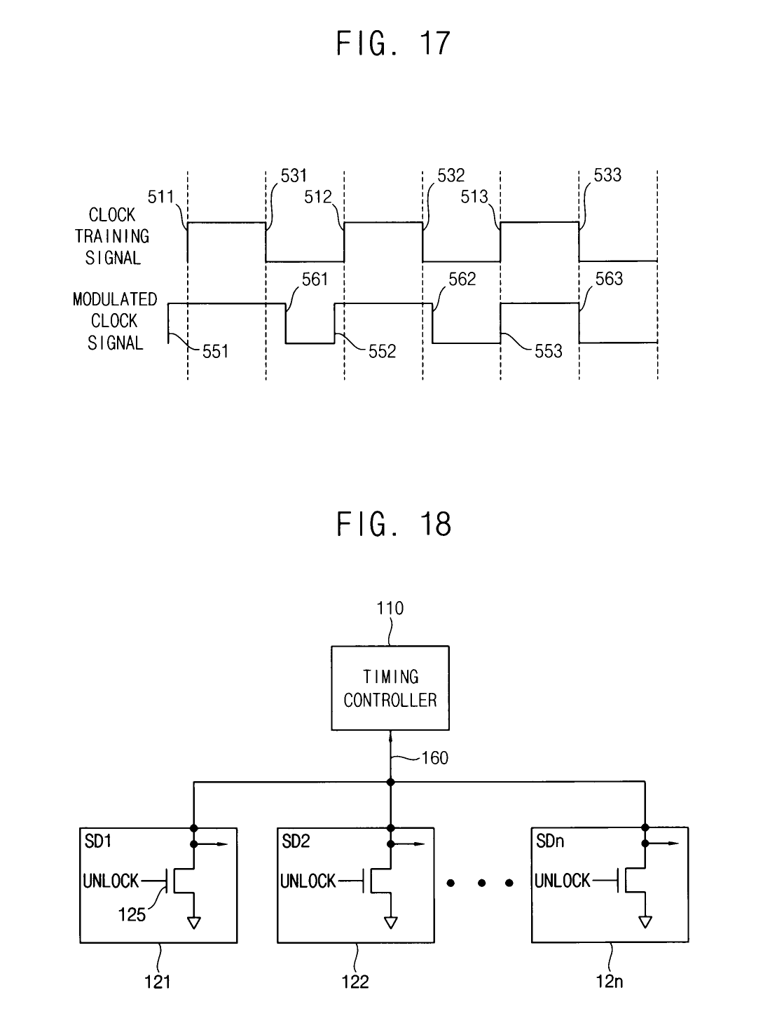

FIG. 17 is a diagram illustrating still another example of a modulated clock signal transferred during a vertical blank period.

Referring to FIG. 17, a modulated clock signal may be generated by modulating rising edges 551, 552 and 553 and falling edges 561, 562 and 563 of a clock training signal. For example, at least some of rising edges 551 and 552 and falling edges 561 and 562 of the modulated clock signal may have positions different from those of rising edges 511 and 512 and falling edges 531 and 532 of the clock training signal. In addition, some of rising edges 553 and falling edges 563 of the modulated clock signal may have positions same as that of rising edges 513 and falling edges 533 of the clock training signal.

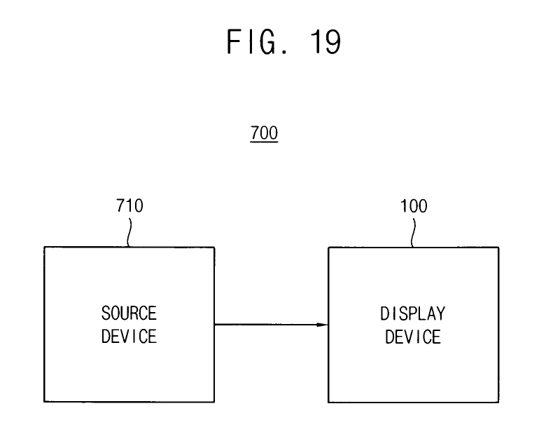

FIG. 18 is a block diagram for describing an example of an operation of a display device of FIG. 1 that transmits soft fail information.

Referring to FIG. 18, a backward signal line 160 may be coupled between a timing controller 110 and source drivers 121˜12n. The source drivers 121˜12n transfer soft fail (lock state) information to the timing controller 110 through the backward signal line 160. The timing controller 110 may know whether the source drivers 121˜12n are locked or unlocked based on the soft fail information transferred through backward signal line 160.

Each of the source drivers 121˜12n may include a transistor 125 which is turned on in response to an unlock signal UNLOCK indicating that a clock recovery unit included in the source driver is unlocked. The transistor 125 may change a voltage of the source node when the clock recovery unit is unlocked. The timing controller 110 may detect the change of the voltage of backward signal line 160, and may know that at least one clock recovery unit included in the drivers 121˜12n is unlocked based on the detected change. In addition, a source driver where a clock recovery unit is not unlocked may know that a clock recovery unit included in another source driver is unlocked by detecting the change of the voltage of the backward signal line 160.

When the timing controller 110 detects the change of the voltage of the backward signal line 160, the timing controller 110 may transmit a clock training signal to the source drivers 121˜12n. The source drivers 121˜12n may be stabilized in response to the clock training signal, and the soft fail may be recovered.

FIG. 19 is a block diagram illustrating a system including a display device of FIG. 1, according to one exemplary embodiment.

Referring to FIG. 19, a system 700 includes a source device 710 and a display device 100.

The source device 710 may provide image data to the display device 100, and the display device 100 may display an image based on the image data. For example, the source device 710 may be a digital versatile disc (DVD) player, a computer, a set top box (STB), a game machine, a digital camcorder, a processor of a mobile phone, PDA, or laptop computer, or the like. The display device 100 may be a television, a monitor, a display device of the mobile phone, etc.

As mentioned above, the example embodiments may be suitable for intra-panel interfaces and may reduce power consumption by each of the source drivers operating based on respective configuration data depending on each channel characteristic.

The present embodiments may be applied to display devices and systems employing intra-panel interface.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of transferring data between a timing controller and a plurality of source drivers in a display device, the method including:
(a) setting a first source driver of the plurality of source drivers to convert first signals received from outside of the first source driver and having first voltage levels to second signals having second voltage levels;
(b) receiving, by the first source driver, a first test pattern from the timing controller;
(c) performing a test by the first source driver, based on the first test pattern, to determine whether an error has occurred in the first test pattern received at the first source driver; and
(d) when an error has occurred in the first test pattern received at the first source driver, adjusting, by the first source driver, an output level of a receiver of the first source driver, so that the first source driver converts the first signals to third signals having third voltage levels different from the second voltage levels.

2. The method of claim 1, wherein performing the test to determine whether an error has occurred includes comparing a voltage level of a signal output from a receiver of the first source driver to a reference voltage level.

3. The method of claim 2, wherein an error is determined to have occurred when the voltage level of the signal output from the receiver is lower than the reference voltage level.

4. The method of claim 1, further comprising:
receiving the first test pattern by the first source driver during an initialization period for the display device.

5. The method of claim 1, further comprising:
receiving the first test pattern by the first source driver during an vertical blank period for the display device.

6. The method of claim 1, further comprising:
(e) setting a second source driver of the plurality of source drivers to convert fourth signals received from outside of the second source driver and having fourth voltage levels to fifth signals having fifth voltage levels;
(f) receiving, by the second source driver, a second test pattern from the timing controller;
(g) performing a test by the second source driver, based on the second test pattern received at the second source driver, to determine whether an error has occurred in the second test pattern received at the second source driver; and
(h) when an error has occurred in the second test pattern received at the second source driver, adjusting, by the second source driver, an output level of a receiver of the second source driver, so that the second source driver converts the fourth signals to sixth signals having sixth voltage levels different from the fifth voltage levels.

7. The method of claim 6, wherein steps (c) and (d) are performed independently of steps (g) and (h).

8. The method of claim 1, further comprising:
repeating steps (b) through (d) for a third test pattern after the output level of the receiver of the source driver has been adjusted; and
continuing to repeat steps (b) through (d) for subsequent test patterns until the source driver determines that no error has occurred in a tested test pattern.

9. The method of claim 1, further comprising:
prior to step (a), performing a test by the first source driver to determine whether an error has occurred in an additional test pattern received at the first source driver; and
if an error has not occurred, performing step (a) by decreasing the output level of the receiver of the first source device.

10. The method of claim 9, further comprising:
repeating steps (b) through (d) for a third test pattern after the output level of the receiver of the source driver has been adjusted; and
continuing to repeat steps (b) through (d) for subsequent test patterns until the source driver determines that no error has occurred in a tested test pattern.

11. A method of transferring data between a timing controller and a plurality of source drivers in a display device, the method including:
(a) receiving, by a first source driver of the plurality of source drivers, a first test signal;
(b) converting, by the first source driver, the first test signal to a first TTL level signal;
(c) performing, by the first source driver, error checking for the first TTL level signal;
(d) if it is determined that an error has occurred, adjusting settings of the first source driver; and
(e) repeating steps (a) through (d) until it is determined that no error has occurred.

12. The method of claim 11, wherein step (c) includes determining whether the first TTL level signal has a voltage level below a reference voltage level.

13. The method of claim 12, wherein step (d) includes adjusting settings of the first source driver to cause a TTL level signal output from a receiver of the first source driver to have a voltage level higher than a voltage level of the first TTL level signal.

14. The method of claim 11, further comprising:
(f) receiving, by a second source driver of the plurality of source drivers, a second test signal;
(g) converting, by the second source driver, the second test signal to a second TTL level signal;
(h) performing, by the second source driver, error checking for the second TTL level signal;
(i) if it is determined that an error has occurred, adjusting settings of the second source driver; and
(j) repeating steps (f) through (i) until it is determined that no error has occurred.

15. A display device comprising:
a timing controller; and
a plurality of source drivers, wherein a first source driver of the plurality of source drivers includes:
a first receiver configured to receive a first test pattern from the timing controller; and
a first error check unit configured to perform a test, based on the first test pattern, to determine whether an error has occurred in the first test pattern,
wherein the first source driver is configured to adjust an output level of the first receiver when it is determined that an error has occurred in the first test pattern, so that signals output from the first receiver have different voltage levels after the adjustment than prior to the adjustment.

16. The display device of claim 15, wherein the first source driver is configured to change settings associated with the receiver to increase the output level of the first receiver when it is determined that an error has occurred in the first test pattern.

17. The display device of claim 15, wherein the first error check unit is further configured to send a ready signal to the timing controller after it is determined that no error has occurred in the first test pattern.

18. The display device of claim 15, wherein a second source driver of the plurality of source drivers includes:
a second receiver configured to receive a second test pattern from the timing controller; and
a second error check unit configured to perform a test, based on the second test pattern, to determine whether an error has occurred in the second test pattern,
wherein the second source driver is configured to adjust an output level of the second receiver, independently of the first source driver, when it is determined that an error has occurred in the second test pattern, so that signals output from the second receiver have different voltage levels after the adjustment than prior to the adjustment.

19. The display device of claim 18, wherein:
the first error check unit is further configured to send a first ready signal to the timing controller after it is determined that no error has occurred in the first test pattern;
the second error check unit is further configured to send a second ready signal to the timing controller after it is determined that no error has occurred in the second test pattern.

20. The display device of claim 19, further comprising:
a first signal path between the timing controller and the first source driver, wherein the timing controller is configured to transmit the first test pattern to the first source driver over the first signal path;
a second signal path between the timing controller and the second source driver, the second signal path different from the first signal path, wherein the timing controller is configured to transmit the second test pattern to the second source driver over the second signal path; and
a third common signal path different from the first signal path and second signal path, wherein both the first source driver and second source driver are configured to send ready signals to the timing controller over the third common signal path.
